(19) United States
(12) Patent Application Publication
(10) Pub. No.: US 2024/0160851 A1
(43) Pub. Date: May 16, 2024

(54) DAY ZERO NATURAL LANGUAGE PROCESSING MODEL

(71) Applicant: Movius Interactive Corporation, Duluth, GA (US)

(72) Inventors: Satish Medapati, Bengaluru (IN); Amit Modi, Fremont, CA (US); ANANTH Siva, Wahroonga (AU)

(73) Assignee: Movius Interactive Corporation, Duluth, GA (US)

(21) Appl. No.: 17/986,865

(22) Filed: Nov. 14, 2022

(51) Int. Cl. G06F 40/40; G06F 16/951; G06F 40/295; G06F 40/35

(52) U.S. Cl. CPC G06F 40/40; G06F 16/951; G06F 40/295; G06F 40/35

(57) ABSTRACT

Generating a “day zero” model as an NLP model that does not need to rely on any specific data obtained from a particular process. As such, the various embodiments are directed to generating a dataset and an NLP model for any industry, field or application that does not have a historical dataset already built that can be utilized. As such, the various embodiments operate to build an applicable data set and NLP model in an automated fashion. This NLP model along with the industry, field or application specific dataset can then be operational on day-zero and provide accurate and relevant results.

### BACKGROUND

Technology is becoming more embedded in our daily lives by the minute. To keep up with the pace of consumer expectations, companies are more heavily relying on learning algorithms to make things easier. You can see its application in social media (through object recognition in photos) or in talking directly to devices (like Alexa or Siri). These technologies are commonly associated with artificial intelligence, machine learning, deep learning, and neural networks.

Artificial Intelligence (AI) is the broadest term used to classify machines that mimic human intelligence. It is used to predict, automate, and optimize tasks that humans have historically done, such as speech and facial recognition, decision making, and translation.

A growing field within the technology realm of artificial intelligence (AI) is the use of Natural Language Processing (NLP). NLP is utilized to enable machines, computers or algorithmic processes to understand and take action on human language, whether verbal utterances or textual, that are received. NLP combines computational linguistics—rule-based modeling of human language—with statistical, machine learning, and deep learning models. Together, these technologies enable computers to process human language in the form of text or voice data and to ‘understand’ its full meaning, complete with the speaker or writer's intent and sentiment.

NLPs are used in a variety of applications, such as telephone sales and customer service centers, digital assistants, home automation systems, mobile telephone voice control interfaces, speech-to-text dictation systems, etc.

Human language, with all of its nuances and ambiguities, tonal inflections as well as facial and hand gestures that may not be detected make it incredibly difficult to create a system that can accurately determine the intended meaning of text or voice data. For example, there are a few irregularities or characteristics of human speech that can make it difficult for even humans to learn. For instance, homonyms, homophones, sarcasm, idioms, metaphors, grammar and usage exceptions, variations in sentence structure, etc. It can take humans years to master such irregularities but, when creating a NLP, the system needs to be an expert right from the start.

NLP involves applying algorithms or heuristics to identify and extract the natural language rules such that the unstructured language data is converted into a form that computers can understand. When the text has been provided, the computer will utilize algorithms to extract meaning associated with every sentence and collect the essential data from them. Sometimes, the computer may fail to understand the meaning of a sentence which can lead to unexpected results.

Two technologies that NLPs may incorporate to interpret language, or pre-process the language, include syntactic analysis and semantic analysis. Syntax refers to the arrangement of words in a sentence such that they make grammatical sense. In NLP, syntactic analysis is used to assess how the natural language aligns with the grammatical rules. Computer algorithms are used to apply grammatical rules to a group of words and derive meaning from them.

Several syntactical techniques can be employed in an NLP:
Lemmatization involves reducing the various inflected forms of a word into a single form for easy analysis;
Morphological segmentation involves dividing words into individual units called morphemes;
Word segmentation involves dividing a large piece of continuous text into distinct units;
Part-of-speech tagging involves identifying the part of speech for every word;
Parsing involves undertaking grammatical analysis for the provided sentence;
Sentence breaking involves placing sentence boundaries on a large piece of text; and
Stemming involves cutting the inflected words to their root form.

Semantic analysis uses semantics. Semantics refers to the meaning that is conveyed by a text. Semantic analysis is one of the difficult aspects of Natural Language Processing that has not been fully perfected yet. In involves applying computer algorithms to understand the meaning and interpretation of words and how sentences are structured.

Some of the techniques used in semantic analysis include:
Named entity recognition (NER), which involves determining the parts of a text that can be identified and categorized into preset groups (e.g., names of people and names of places);
Word sense disambiguation, which involves giving meaning to a word based on the context; and
Natural language generation, which involves using databases or datasets to derive semantic intentions and convert them into human language.

After pre-processing data, it needs to be fed through an NLP algorithm to interpret the language and perform tasks or responses. Traditionally, two main algorithms have been used to solve NLP problems: (a) a rule-based approach and (b) machine learning algorithms. A rule-based system relies on hand-crafted grammatical rules that need to be created by experts in linguistics, or knowledge engineers. Machine learning algorithms are based on statistical methods and learn to perform tasks after being fed examples (i.e., training datasets).

With the use of neural networks, deep learning, machine learning, NLPs can grow in their abilities to accurately and effectively process language. However, one of the key elements in an NLP system is being operable and product at day zero, the moment the system goes live for a particular company, industry, etc. One of the key elements in having day zero operation is the building of effective and relevant datasets. Thus, there is a need in the art for a system and technique to generate application, use and industry specific datasets to enable to enable day zero effectiveness for an NLP.

With the advent of newer companies and new processes, and even new industries, the existing, off-the-shelf datasets are impractical. As datasets attempt to be applicable across industries, they are generally large, bulky, difficult to maintain and in many instances, simply inefficient. The “one size fits all” model provides great marketability arguments but, at the end of the day, all end up suffering some degree of inefficiency in exchange for genericness.

An NLP model is as good as the dataset on which it has been trained. Thus, there is a need in the art for a system and method to generate datasets that advantageously focus on training an NLP system in a specific field, industry or use.

### BRIEF SUMMARY

Generating a “day zero” model as an NLP model that does not need to rely on any specific data obtained from a historical data process. As such, the various embodiments are directed to generating a dataset and an NLP model for any industry, field or application that does not have a historical dataset already built that can be utilized. As such, the various embodiments operate to build an applicable data set and NLP model in an automated fashion. This NLP model along with the industry, field or application specific dataset can then be operational on day-zero. Advantageously, this efficiency saves time, brings machine learning models to the market faster and provides accurate and relevant results.

### BRIEF DESCRIPTION OF THE SEVERAL VIEWS OF THE DRAWING

FIG. 1 is a high-level flow diagram of the operation of various embodiments of the process of creating a day-zero NLP model.

FIG. 2 is a flow diagram illustrating exemplary steps, processes and flows for synthesizing training data sets to deploy a day zero NLP model.

FIG. 3 is a table illustrating a non-limiting example of a list of intents 302 and sample questions that can be generated relevant to the intents 304.

FIG. 4A is an example of chat sessions between human agents and customers that can generate historic data to mine for intents in the generation of the corpus.

FIG. 4B is an example of chat sessions between human agents and customers that can generate historic data to mine for intents in the generation of the corpus.

FIG. 5 illustrates how intents can be generated from chat data.

FIG. 6 is a table illustrating 10 exemplary intents that could be provide by an expert along with sub intents.

FIG. 7 is an exemplary language model that can be used to generate variations on the questions.

FIG. 8 is an exemplary twitter feed that could be parsed to identify intents.

FIG. 9 is a table showing sentence or question variations that can be generated based on linguistic patterns.

FIG. 10 is a table illustrated the input seeds 1002, the question obtained as a result of the search 1004, the intent related to the question and the seed 1006 and the similarity score attributed to the search results 1008.

FIG. 11 is a functional block diagram of the components of an exemplary embodiment of system or sub-system operating as a controller or processor 1100 that could be used in various embodiments of the disclosure for controlling aspects of the various embodiments.

FIG. 12 is a conceptual block diagram illustrating an exemplary environment for deployment of the various embodiments.

### DETAILED DESCRIPTION OF VARIOUS EMBODIMENTS ON

The present invention, as well as features and aspects thereof, is directed towards providing a “day zero” model as an NLP model that does not need to rely on any specific historical data obtained from a particular process. As such, the various embodiments are directed to generating a dataset and an NLP model for any specific industry, field or application that does not have a historical dataset already built that can be utilized. As such, the various embodiments operate to build an applicable data set and NLP model in an automated fashion. This NLP model along with the industry, field or application specific dataset can then be operational on day-zero and provide accurate and relevant results.

For example, in an ecommerce situation, if there is no data on product recommendation queries from actual customers, embodiments of the present invention can generate a dataset that enables an NLP model to understand what the customers queries are about and then to solve their product queries with great accuracy from the time of deployment. This will be the fastest way to get to market with an NLP bot without having too many cycles in data collection and ML model building

Another example can be appreciated in an emerging field, such as electric vehicles or EVs. Prior to the advent of such products, there would be no dataset that is applicable to serve as the basis for an NLP model. However, the various embodiments can be utilized to automatically create such a dataset that an NLP model can be trained on and that is ready for deployment prior to the selling of any of the EVs.

NLPs work primarily on predicting intents and entities, both of which require training utilizing data that is relevant and contextual to the specific client and problem. Intent in NLP is the outcome of a behavior or the intentions of the end-user. These intentions or intents are conveyed by the user to the NLP model or the bot running the model.

Entities is metadata associated with the intent.

Intent refers to the goal the customer has in mind when typing in a question or comment or talking to a bot. For instance, the following queries are associated with the identified intents:
Is there a charge on my account? (Intent: Fee Charged)
Can you waive it? (intent: fee waiver)?
Where the heck is my order? (intent: order status)

While entity refers to the modifier the customer uses to describe their issue, intent is what they really mean. Entities could be any attributes or descriptions or nomenclature and sometimes specific to context.

One of the biggest challenges for deploying an NLP model right out on day-zero is the lack of relevant training datasets that are specific to that process. In addressing this challenge, various embodiments include a novel method that operates to synthesize training data sets so as to deploy a day zero NLP model for any interaction.

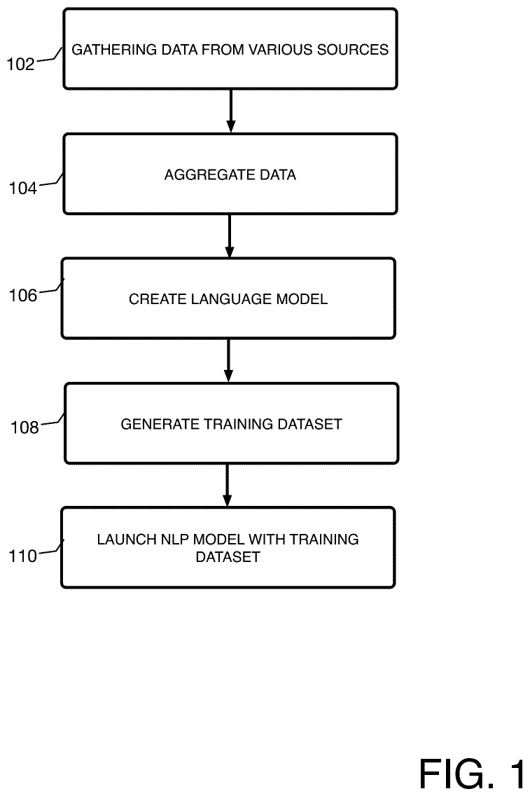

FIG. 1 is a high-level flow diagram of the operation of various embodiments of the process of creating a day-zero NLP model. The premises of the various embodiments is to create a unique synthesized dataset that is applicable and relevant for a particular industry, application or process and that can be used by the NLP model to provide day-zero operation and also for training. Initially the process goes through a data synthesis process to generate relevant data from a variety of sources 102. The various sources are used to create one set of data. Next, multiple datasets are generated using both linguistic rules and sequence models to obtain a vast data corpora (i.e., each corpus being based on various input) that would solve for the lack of relevant training datasets. A corpus is a collection of text or audio organized into datasets. A corpus can be made up of everything from newspapers, novels, recipes, radio broadcasts to television shows, movies, and tweets. In natural language processing, a corpus contains text and speech data that can be used to train artificial intelligence (AI) and machine learning systems.

For linguistic rules, an AI interface developer takes a linguistic engine that has knowledge of a given language's syntax, semantics and morphology (how words are built) and then adds program rules that look for the key semantic concepts that determine that a sentence has a certain meaning (e.g., if it is told to look for the word balance, it automatically knows to also look for related words such as money/cash/savings, etc.).

As in the ML-based approach, designers then repeat the above process for every intent they want the bot to distinguish—i.e., for every distinct question they want answered. When the engine is deployed after that programming phase is done, it will conclude “the customer means BALANCEINQUIRY” when it sees a sentence that is either exactly like the one it was trained for, or ones that are similar in terms of the meaning.

In both cases, once the engine has determined that the user intent was BALANCEINQUIRY, the chatbot script will then have logic that asserts, “If intent was BALANCEINQUIRY, then look up balance from backend and present it.”

Sequence models are the machine learning models that input or output sequences of data. Sequential data includes text streams, audio clips, video clips, time-series data and etc. Recurrent Neural Networks (RNNs) is a popular algorithm used in sequence models. Sequence models are a very common sequence modeling technique in machine learning that is used for analyzing sequence data. Sequence data are the data points which are ordered in the meaningful manner such that earlier data points or observations provide the information about later data points or observations. The time series data is an example of sequence data which can be defined as a sequence of observations where each observation is dependent on the previous one. Sequence data can be represented as observations of one or more characteristics of events over time.

In general, the larger the size of a corpus, the better. Large quantities of specialized datasets are vital to training algorithms. High quality is important when it comes to the data within a corpus. Due to the large volume of data required for a corpus, even minor errors in the training data can lead to large-scale errors in the machine learning system's output. Data cleansing is also important for creating and maintaining a high-quality corpus. Data cleansing allows identifying and eliminating any errors or duplicate data to create a more reliable corpus for NLP. A high-quality corpus is a balanced corpus. While it can be tempting to fill a corpus with everything and anything available, if one doesn't streamline and structure the data collection process, it could unbalance the relevance of the dataset.

As such, pre-processing can be applied to the data in a corpus. Such processing includes but is not limited to the following tasks:
tokenization—converting sentences to words;
removing unnecessary punctuation, tags;
removing stop words—frequent words such as “the”, “is”, etc. that do not have specific semantic;
stemming—words are reduced to a root by removing inflection through dropping unnecessary characters, usually a suffix (ie. “ed”, “ing”, “s”, “es” etc.); and
lemmatization—Another approach to remove inflection by determining the part of speech and utilizing detailed database of the language.

In text processing, words of the text represent discrete, categorical features. How do we encode such data in a way which is ready to be used by the algorithms? The mapping from textual data to real valued vectors is called feature extraction. One of the simplest techniques to numerically represent text is Bag of Words.

In implementing a bag of words representation make a list of unique words in the text corpus, which is called vocabulary. Next, represent each sentence or document as a vector with each word represented as 1 for present and 0 for absent from the vocabulary. Another representation can be count the number of times each word appears in a document. The most popular approach is using the Term Frequency-Inverse Document Frequency (TF-IDF) technique.

Term Frequency (TF)=(Number of times term t appears in a document)/(Number of terms in the document)

Inverse Document Frequency (IDF)=log(N/n), where, N is the number of documents and n is the number of documents a term t has appeared in. The IDF of a rare word is high, whereas the IDF of a frequent word is likely to be low. Thus having the effect of highlighting words that are distinct.

TF-IDF value of a term is calculated as=TF*IDF

One of the major disadvantages of using BOW is that it discards word order thereby ignoring the context and in turn meaning of words in the document. For natural language processing (NLP) maintaining the context of the words can be of some importance. To solve this problem another approach called Word Embedding can be employed.

Word embedding is a representation of text where words that have the same meaning have a similar representation. In other words it represents words in a coordinate system where related words, based on a corpus of relationships, are placed closer together.

There are two popular models of word embedding Word2Vac and Glove.

Word2vec takes as its input a large corpus of text and produces a vector space with each unique word being assigned a corresponding vector in the space. Word vectors are positioned in the vector space such that words that share common contexts in the corpus are located in close proximity to one another in the space. Word2Vec is very famous at capturing meaning and demonstrating it on tasks like calculating analogy questions of the form a is to b as c is to ?. For example, man is to woman as uncle is to ? (aunt) using a simple vector offset method based on cosine distance. For example, here are vector offsets for three word pairs illustrating the gender relation:
Man: Woman
Uncle: Aunt
King: Queen

This kind of vector composition allows the question “King−Man+Woman=?” to arrive at the result “Queen”. Thus, this knowledge is derived from looking at lots of words in context with no other information provided about their semantics.

Glove, or Global Vectors for Word Representation, is an algorithm that is basically an extension to the word2vec method for efficiently learning word vectors. GLOVE constructs an explicit word-context or word co-occurrence matrix using statistics across the whole text corpus. The result is a learning model that may result in generally better word embeddings.

Machine learning (“ML”) is then applied to the corpus. There are various approaches to building ML models for various text based applications depending on the problem space and data available. Classic ML approaches like ‘Naive Bayes’ or ‘Support Vector Machines’ for spam filtering has been widely used. Deep learning techniques are giving better results for NLP problems like sentiment analysis and language translation. Deep learning models are very slow to train and it has been seen that for simple text classification problems classical ML approaches as well give similar results with quicker training time.

In creating a corpus, one of the first steps is to decide the scope of the corpus, including the type of data needed to solve the task at hand—such as a customer interface for a particular industry. Further, the availability and quality of the data needs to be assessed to determine if it is adequate to meet the desired outcome. If not, additional data may need to be generated. Further, when creating corpora for specific industries, the designer can limit the scope of the corpora based on a variety of parameters including language, genre, size, relevancy of the data (i.e., how old is the data), etc.

Thus, a corpus can be assembled from a variety of sources and genres. Such a corpus can be used for general NLP tasks. On the other hand, a corpus might be from a single source, domain or genre. Such a corpus can be used only for a specific purpose.

A plain text corpus is suitable for unsupervised training. Machine learning models learn from the data in an unsupervised manner. However, a corpus that has the raw text plus annotations or entities can be used for supervised training. It takes considerable effort to create an annotated corpus but it may produce better results.

Part-of-speech is one of the most common annotations because of its use in many downstream NLP tasks. Annotating with lemmas (base forms), syntactic parse trees (phrase-structure or dependency tree representations) and semantic information (word sense disambiguation) are also common. For discourse or text summarization tasks, annotations aid coreference resolutions.

Audio/video recordings can be transcribed and annotated as well. Annotations are phonetic (sounds), prosodic (variations), or interactional. Video transcripts may annotate for sign language and gesture. Annotations could be inline/embedded with the text. When they appear on separate lines, it's called multi-tiered annotation. If they're in separate files, and linked to the text via hypertext, it's called standalone annotation.

If a user has a specific problem or objective they want to address, they'll need a collection of data that supports, or at least is a representation of, what they're looking to achieve with machine learning and NLP.

The data from the various data corpora are then aggregated to a single corpus 104. This aggregated corpus is then used to create a language model 106, which in turn is used to generate a training data set 108. Finally, once the training dataset is created, the NLP model can be launched with the training dataset as a day-zero operational and relevant NLP model.

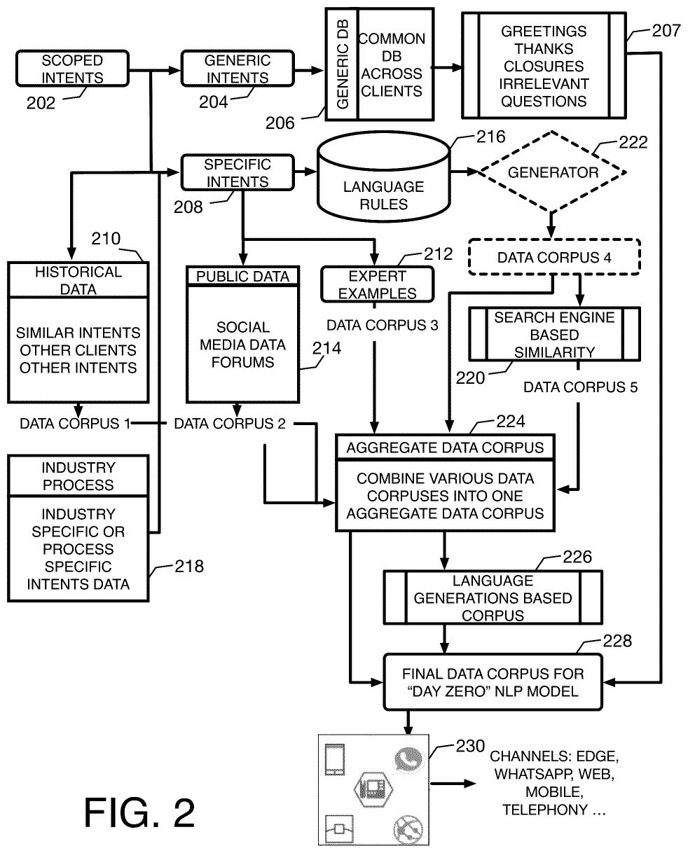

FIG. 2 is a flow diagram illustrating exemplary steps, processes and flows for synthesizing training data sets to deploy a day zero NLP model.

Scoped Intents: Initially, a definitive boundary or a scope for the intents to be covered in the day-zero NLP model needs to be identified or defined 202. The primary exercise is to segregate the scoping of what intents would be covered in the day-zero NLP model and what would be excluded across both generic and specific intents. In defining the scope, one parameter would be the number of intents to be handled. A particular model may handle ‘X’ set of finite specific and generic intents through the NLP model and exclusions would be handled separately.

Generic Intents: Next a set of generic intents need to be defined for the day-zero model 204. As and when people generally talk, there are pleasantries exchanged as well as some common discussions that happen between two people. Similarly, when someone interacts with a bot, they would expect pleasantries to kick start the conversation. Similarly, the ending of a conversation would elicit responses such as Thank you or Appreciations for the problem solved or may be another complaint. We classify these type of intents as closure intents and they are part of the generic intents.

Any other irrelevant queries that are not related to either business or the processes would have to be in the exclusion criteria of handling. All this data corpus will also be stored.

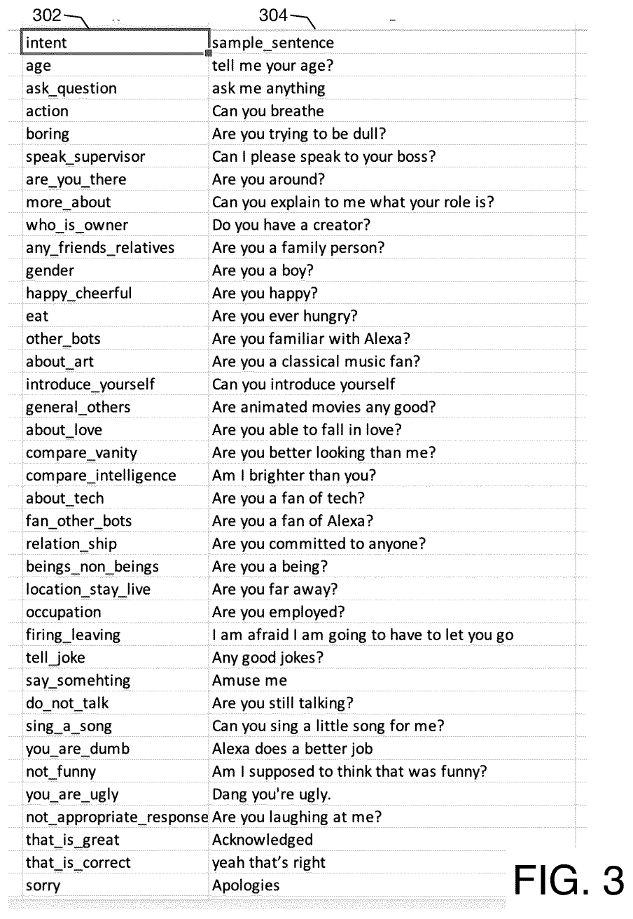

Generic DB: Once the generic intents are identified, they will all be stored into one Generic DB 206. The Generic DB is utilized across clients and these would remain similar irrespective of the process or the industry. For example, generic intents such as saying Hi, hello or thanking or acknowledging a customer complaint etc. 207. FIG. 3 is a table illustrating a non-limiting example of a list of intents 302 and sample questions that can be generated relevant to the intents 304.

Specific Intents: In addition, specific intents are also defined 208. These specific intents are non-generic in nature and are specifically applicable to the business for which the NLP model is being trained to answer or service. These intents are related to the operational queries raised by the customer on his/her transactions with that business. For instance, it could be a credit card charge reversal status query from a customer and this would pertain to his/her card and the specific institution. These are termed as specific intents. As an example, suppose an intellectual property attorney is setting up a call processing bot to handle general inquiries from potential and existing clients. The process to generate the datasets for day-zero NLP includes:

To generate specific intents for this process, we need to get some search results of search engines such as GOOGLE, BING, etc. for some queries related to this process. These questions are generated by using simple language rules.

Some of the questions in such an example could be (a) what is a trademark? (b) what is a patent? (c) what is a copyright? (d) what is a trade secret? (e) what is trade dress? etc.

The data received from each of these searches can be parsed or scraped, such as comparing the headings of the search results with the questions entered. Further, some search engines provide related searches that are suggested to the searcher. For instance, in one example the search engine may also suggest the following questions/searches: (a) how to get a trademark; (b) what is a trademark definition; (c) what is a registered trademark; (d) what does it mean to trademark; (e) trademark sign symbol; (f) can you trademark a phrase etc

Web APIs are used to crawl related questions rather than manually selecting them. This will provide a rich set of similar search queries and their results.

All then crawled questions are then scored on similarity models so as to take the most similar queries for our purpose. A corpus is built from linguistic rules and matching questions to generate more queries. This information is then joined together and utilized to generate or create a corpus.

This corpus is then annotated to get the day-zero datasets along with the other datasets we have worked on.

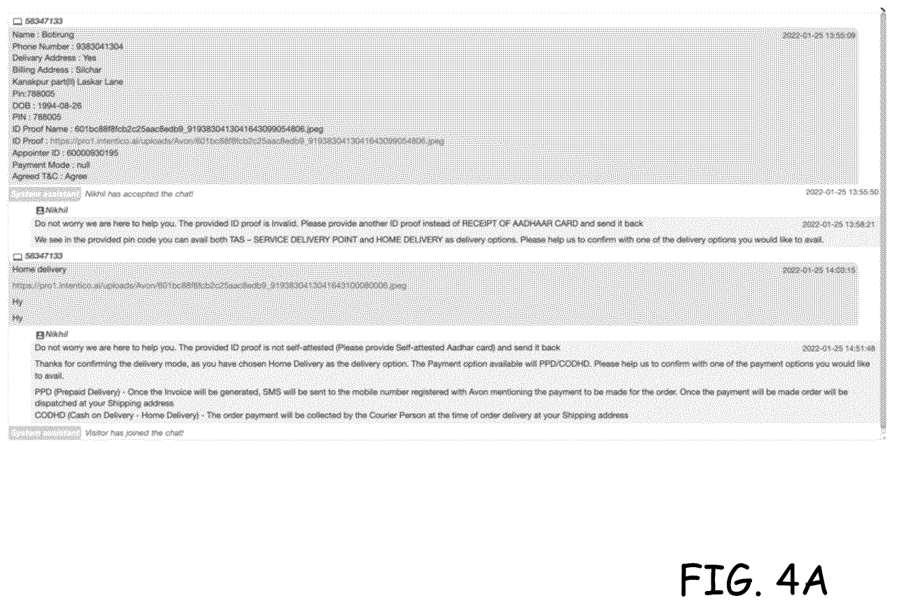

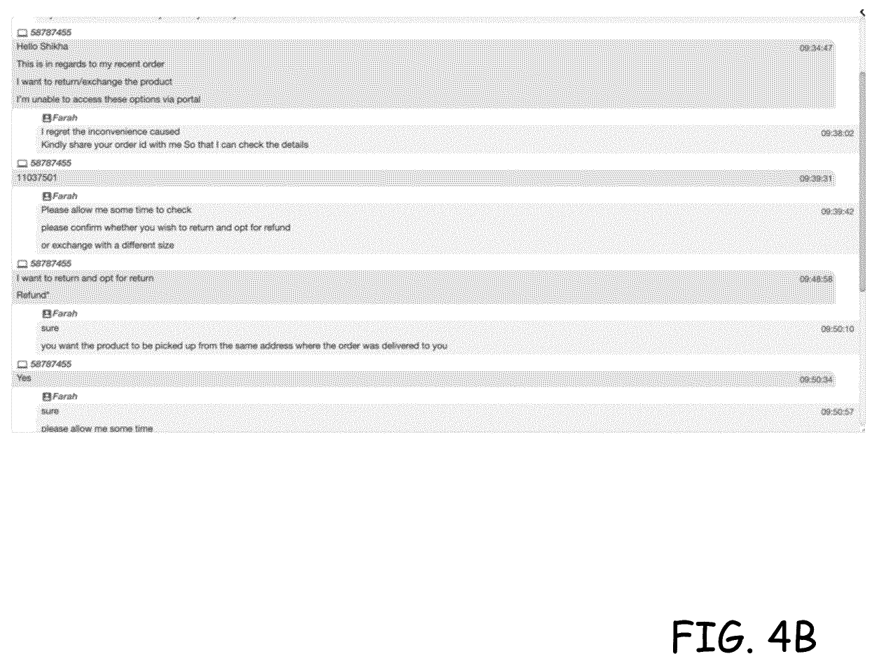

Historical Data: Much information can be obtained from mining historical data. As such, any historical data that pertains to the afore described intents and entities can be taken from other clients and incorporated into the dataset 210. This can also include any chat data of the same customer (non bot transactions) which can also be taken as an input data set. Any other intents for the same client could also help frame the user queries. The historical data results in the generation of a first data corpus (DATA CORPUS 1). FIGS. 4A and 4B is an example of chat sessions between human agents and customers that can generate historic data to mine for intents in the generation of the corpus. Conversation in FIG. 4A provides examples of ordering a product while the conversation inf FIG. 4B provides examples of requesting a product return. An algorithm can scrape the content of such conversations to identify typical questions to be asked in a related or similar industry.

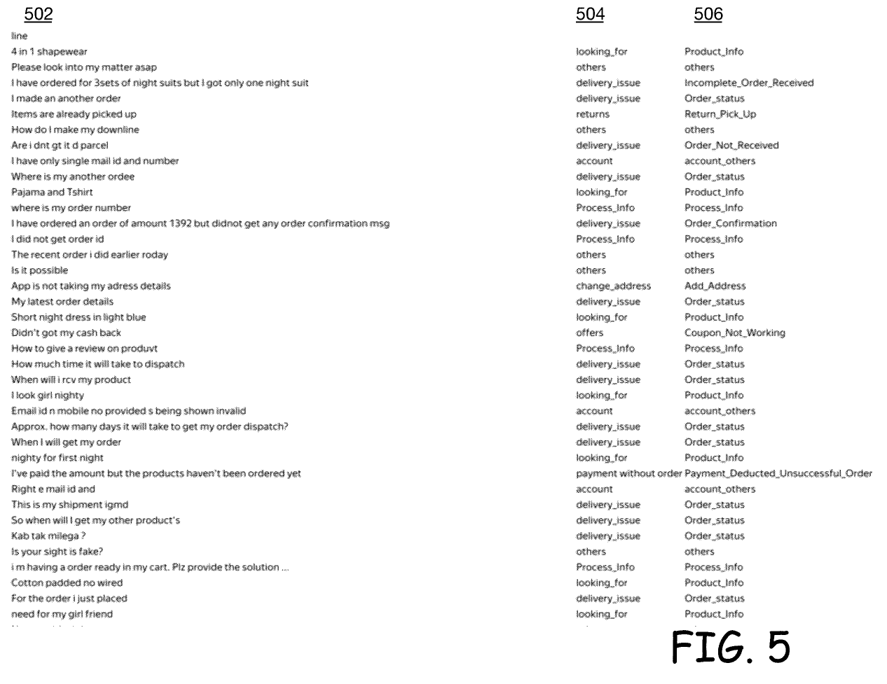

For instance, the table in FIG. 5 illustrates how intents can be generated from chat data. Column 502 lists typical lines of texts that could be obtained in a chat session. Columns 504 and 505 illustrate intents that can be generated from the chat lines.

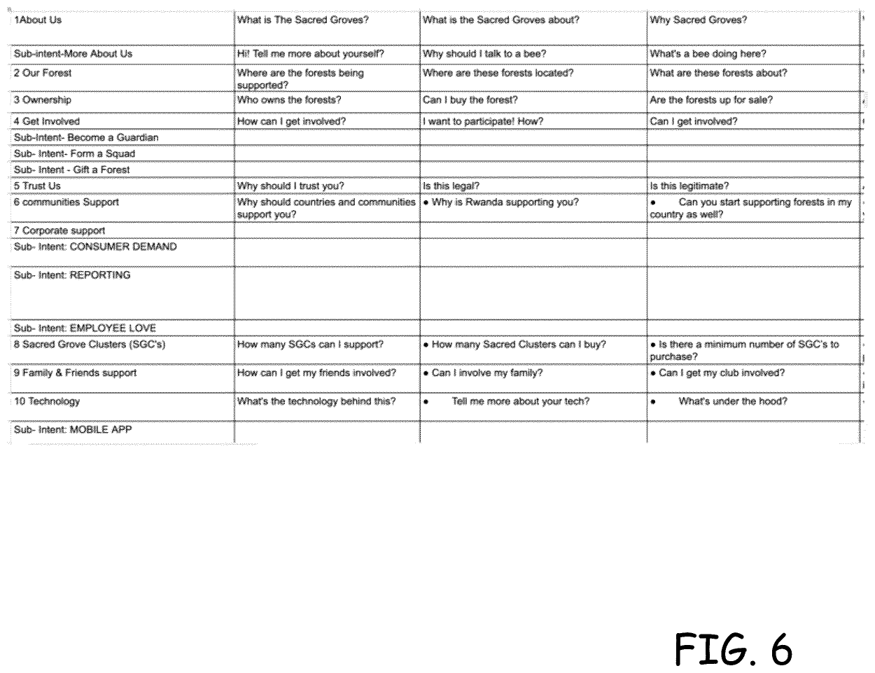

Expert Examples: Expert examples are created by either an algorithmic or manual synthesis of a sample data for the intents 212. This is achieved by asking experts in the relevant industry (or observing operations) to craft a few intent based lines that the NLP model can learn from. These lines are specifically written by experts who understand how a user would enquire for the specific intent at various stages of the lifecycle but could be obtained from operational data or observation. The expert examples result in the generation of DATA CORPUS 3. FIG. 6 is a table illustrating 10 exemplary intents that could be provide by an expert along with sub intents. Further, for each intent variations of questions related to the intents are illustrated.

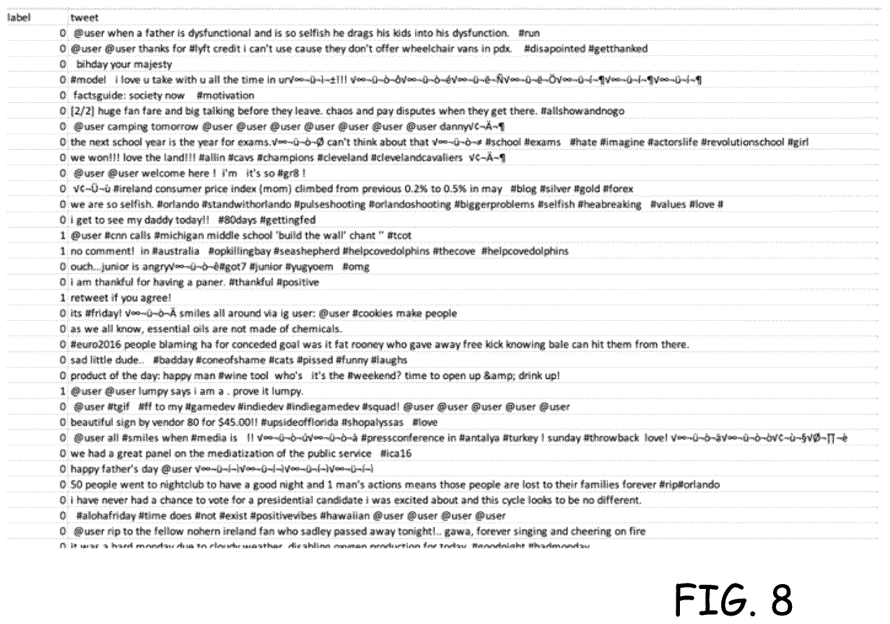

Public Data: A number of intents can be gathered from public data, such as social media data forums as a non-limiting example 214. As an example, any refund related queries on social media sites like Facebook posts, tweets, reddit posts, medium articles or any other queries posted on online forums. FIG. 8 is an exemplary twitter feed that could be parsed to identify intents. There will be a lot more of data that can be derived from online complaint portals. The intent related data alone will be scraped and a public data corpus created and maintained (DATA CORPUS 2).

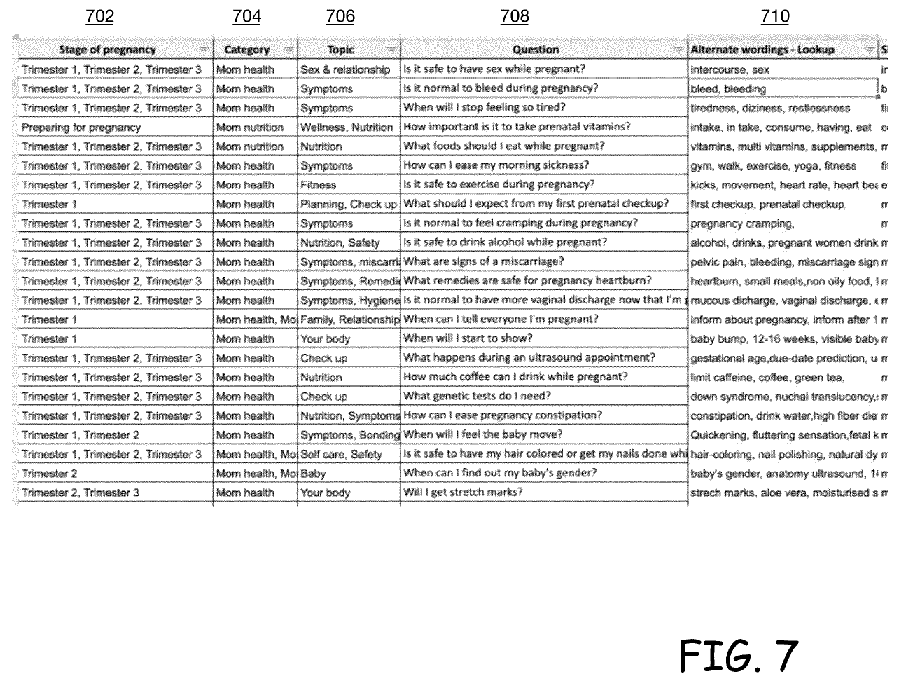

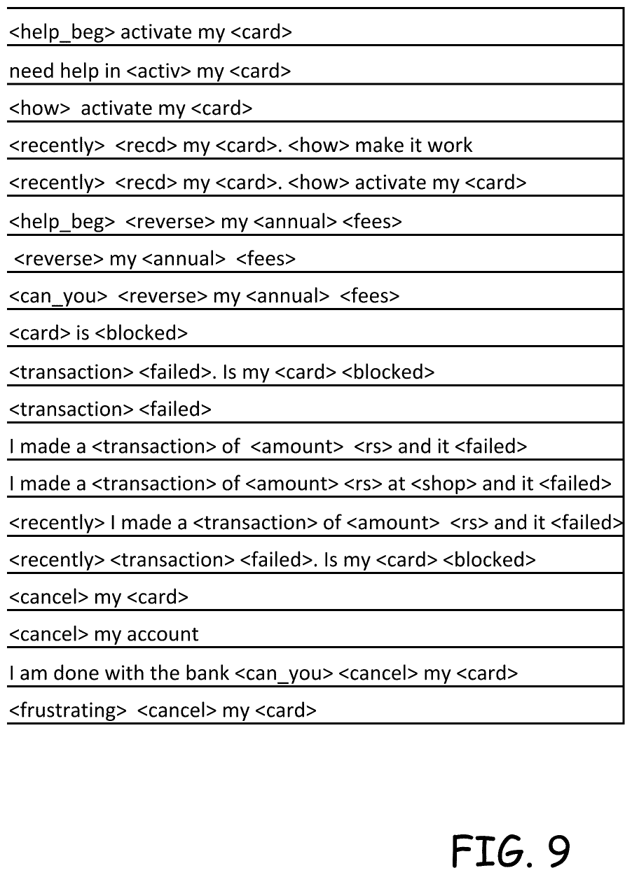

Language Rules & Generator: Language rules can then be built to generate sentences for the specific intents of interest 216. Sentences are generated for the intents by randomly picking up the list of words and loop this list 222 to create a corpus of data (DATA CORPUS 4). A machine learning model can be used by one or more data scientist to generate the data corpus based on the language rules that have been produced to create the intents. It should be appreciated that the same inquiry can be made by a wide variety of sentences using different words and different structures and being received in different channels. The language rules and generator operate to identify variations of the questions. FIG. 7 is an exemplary language model that can be used to generate variations on the questions. Column 702 in FIG. 7 presents various stages of pregnancy that are relevant to various categories 704 and topics 706. Column 708 illustrates an exemplary question related to the stage of pregnancy 702, category 704 and topic 706. Column 710 provides a list of potential substitute words that could be utilized in the sentence. FIG. 9 is a table showing sentence or question variations that can be generated based on linguistic patterns.

Industry & Process: Based on the industry for which the day zero model is being generated, all the existing data based on practical industry experience such as healthcare or banking etc. can be assimilated 218 and an aggregate level of intelligence derived from that industry is used for training the model.

Alternately, there may be processes that are common across multiple industries. For example the process of collections is common across mortgages, auto loans or insurance and we may use the collective intelligence obtained from other clients' on the same process for training datasets.

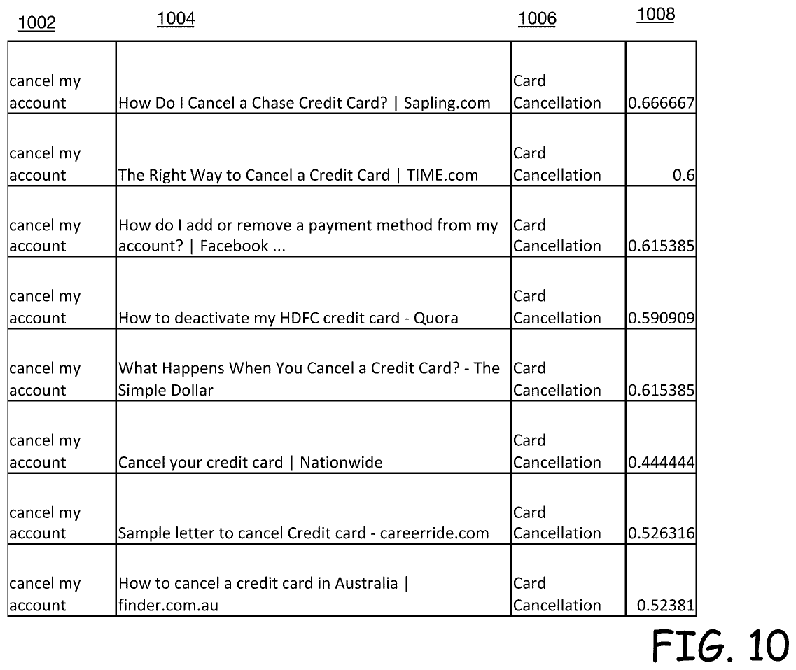

Search Engine based Similarity Data: With the Language model and a generated corpus, a search engine based search can be initiated for identifying similarity data 220. Utilizing the seed data and hit search engines, such as BING as a non-limiting example, and get the title of the article that is related to the search seed. After this, the process can ensure that the sentences are clean with respect to the intent and follow some basic rules as depicted in the search engine similarity data. For instance, this process can ensure the sentences are few words and have more nouns than other words. The basic questions are as depicted in the search engine similarity data for the queries that we have synthetically generated already. What is being compared for similarity through the search engine data crawling is the synthetic data so as to make it rich and varied. As a result the search engine process generates DATA CORPUS 5 and a similarity score. FIG. 10 is a table illustrating the input seeds 1002, the question obtained as a result of the search 1004, the intent related to the question and the seed 1006 and the similarity score attributed to the search results 1008.

Unified or Aggregated Data Corpus: For each of the identified data corpora created, a unified aggregate data corpus of all the individual data corpora can be generated or used 224—(i.e., historical data corpus (DATA CORPUS 1), public data corpus (DATA CORPUS 2), expert systems data corpus (DATA CORPUS 3), language data corpus (DATA CORPUS 4), search engine based similarity data (DATA CORPUS 5)) into one single data corpus bundle referred to as the Aggregate Data Corpus.

Language Generation based Corpus: By having the seed data as well as the Aggregate Data Corpus, the intent corpus data with machine learning algorithms such as RNNs (recurrent neural networks) can be automatically generated 226. The sentence length, key words, start words of a sentence etc., can all be tweaked or adjusted all without any manual input to the actual sentences that form the intents. This process is completely independent of the language rules generated data as the sentences for a specific intent are not generated based on any rule set provided by a human, but rather is fully generated by an algorithm. The generated sentences can be padded and normalized (i.e. digits, dollars, etc.) In operation, a list of starting words can be created. The starting words can be selected, such as randomly, and fed into the RNN model to generate a random sentence length.

Final Data Corpus for NLP Day-Zero Model: With all the above specific intents based datasets integrated into the generic intent data sets, the training data for the target NLP model can then be executed such that upon deployment, the NLP model is set to run on day-zero with a significant accuracy and without any specific intent training data sets 228.

Channel/Delivery: The generated day-zero intelligence models work across channels such as whatsapp, cloud telephony, websites, mobile devices and edge nodes that have necessary computing power 230.

From the forgoing description, it should be appreciated that the day-zero models are built with the context of Industry and process and in order to improve the process once the model goes live. The generation process gets improvising with the advent of live data; however, this generated data is not with respect to users or personalization.

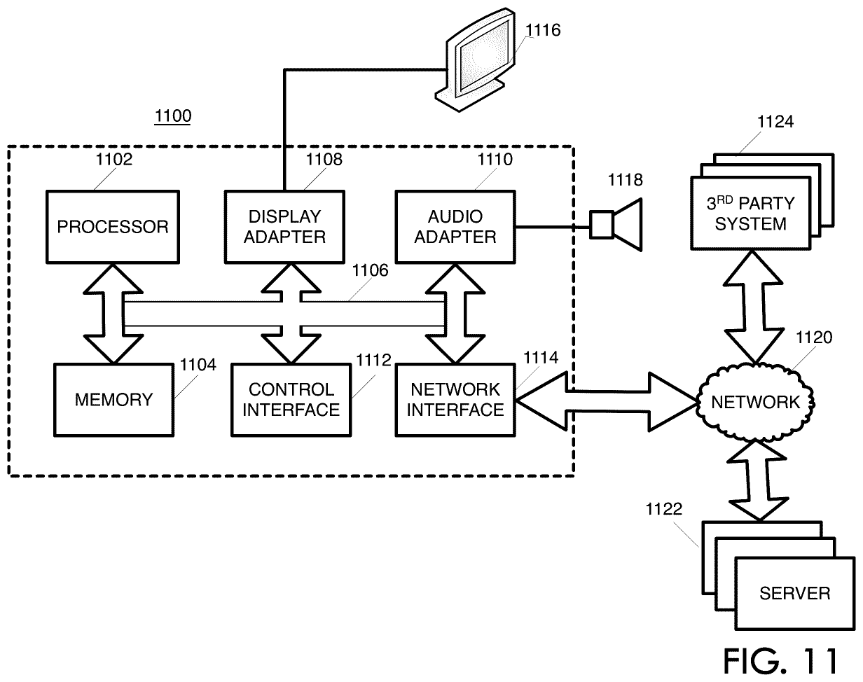

FIG. 11 is a functional block diagram of the components of an exemplary embodiment of system or sub-system operating as a controller or processor 1100 that could be used in various embodiments of the disclosure for controlling aspects of the various embodiments. FIG. 11 could server as the backbone or platform for any of the components, systems or devices presented herein, including but not limited to servers, mobile devices, computers, subscriber devices, networked devices, etc. It will be appreciated that not all of the components illustrated in FIG. 11 are required in all embodiments of the activity monitor but, each of the components are presented and described in conjunction with FIG. 11 to provide a complete and overall understanding of the components. The controller can include a general computing platform 1100 illustrated as including a processor/memory device 1102/1104 that may be integrated with each other or, communicatively connected over a bus or similar interface 1106. The processor 1102 can be a variety of processor types including microprocessors, micro-controllers, programmable arrays, custom IC's etc. and may also include single or multiple processors with or without accelerators or the like. The memory element of 1104 may include a variety of structures, including but not limited to RAM, ROM, magnetic media, optical media, bubble memory, FLASH memory, EPROM, EEPROM, etc. The processor 1102, or other components in the controller may also provide components such as a real-time clock, analog to digital convertors, digital to analog convertors, etc. The processor 1102 also interfaces to a variety of elements including a control interface 1112, a display adapter 1108, an audio adapter 1110, and network/device interface 1114. The control interface 1112 provides an interface to external controls, such as sensors, actuators, drawing heads, nozzles, cartridges, pressure actuators, leading mechanism, drums, step motors, a keyboard, a mouse, a pin pad, an audio activated device, as well as a variety of the many other available input and output devices or, another computer or processing device or the like. The display adapter 1108 can be used to drive a variety of alert elements 1116, such as display devices including an LED display, LCD display, one or more LEDs or other display devices. The audio adapter 1110 interfaces to and drives another alert element 1118, such as a speaker or speaker system, buzzer, bell, etc. The network/interface 1114 may interface to a network 1120 which may be any type of network including, but not limited to the Internet, a global network, a wide area network, a local area network, a wired network, a wireless network or any other network type including hybrids. Through the network 1120, or even directly, the controller 1100 can interface to other devices or computing platforms such as one or more servers 1122 and/or third party systems 1124. A battery or power source provides power for the controller 1100.

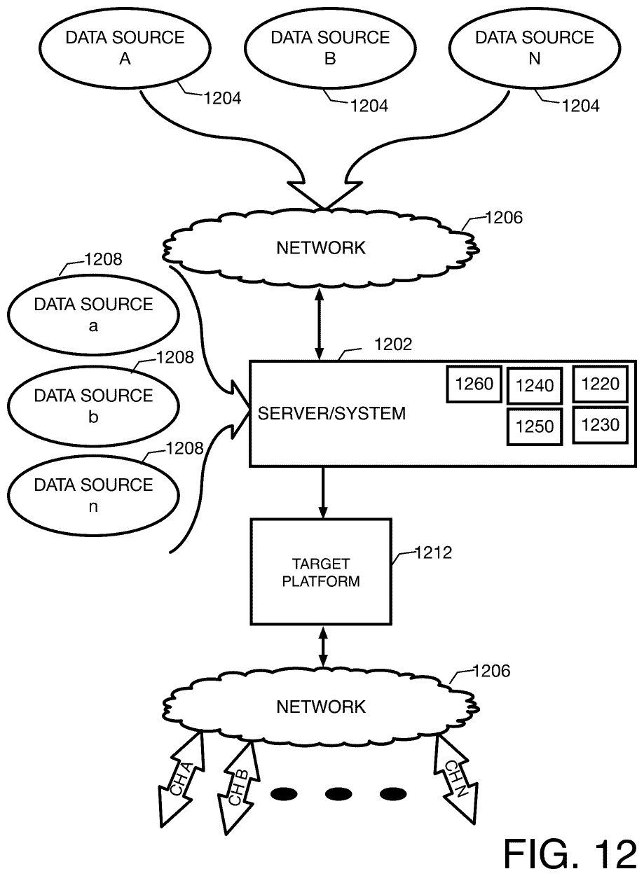

FIG. 12 is a conceptual block diagram illustrating an exemplary environment for deployment of the various embodiments. Server/System 1202 houses the dataset generator as depicted in FIG. 2. As such, the algorithms, modules, software units, programs etc. necessary to collect information and generate corpora and datasets are housed within the Server/System 1202, which may consist of a single server or multiple server co-located or distributed in various locations. The server system 1202 includes: a data collector 1220 that is configured to gather data from one or more sources with each of the sources including data that is relevant to the particular industry; an aggregator 1230 that is configured to aggregate the gathered data; a language model generator 1240 that is configured to create a language model from the aggregated data; a dataset generator 1250 that is configured to generate a training dataset; and a processor 1260 that is configured to execute a natural language processing model with the training dataset such that the natural language processing model is functional to the relevant industry upon launching.

The server system is illustrated as interfacing with one or more data sources 1204 (DATA SOURCE A, DATA SOURCE B, DATA SOURCE N) through network 1206. Further, the Server/system 1202 may also interface with one or more data sources 1208 (DATA SOURCE a, DATA SOURCE b, DATA SOURCE n) directly, without going through the network 1202, such as interfacing to a local database, internal memory or even receiving direct input from a user.

As previously described, these data sources may include sources of historical data, such as similar intents, other intents or other clients (210), industry process, such as industry specific or process specific intents data (218), public data, such as social media data forums (214), expert examples provided from industry experts (212), generic intents (204), etc.

The server/system 1202 also includes the algorithm to implement the language rules 216 and generator 222. Further, the server/system 1202 includes the algorithm to conduct searches based on one or more data corpora 220 and to score the search results.

The server/system 1202 generates one or more corpora from the data received and then operates to aggregate the multiple corpora into a single aggregated data corpus. The server/system 1202 also includes an algorithm to conduct machine learning, such as RNN, to automatically generate the intent corpus data. This process is completely independent of the language rules generated data as the sentences for a specific intent are not generated based on any rule set provided by a human, but rather is fully generated by an algorithm. The resulting data is what is required for the day zero dataset and thus, can then be loaded into a target platform 1212.

In either of the configurations, the NLP model can be exercised from devices or application over various channels (i.e Channel A, Channel B, Channel N).

The target platform 1212 maybe the same as the server/system 1202 or it may be a different system dedicated to the customer for which the NLP model has been developed. In the latter embodiment, the NLP model along with the dataset can be loaded into the target platform 1212 and launched. Upon launch the NLP model is ready to service inquiries right out the gate but, it also learns more as others interact with it. In some embodiments, the dataset may remain on the server/system 1202 and only the NLP model is on the target platform 1212. In other embodiments, the dataset may be loaded onto the target platform 1212 but the NLP model remains on the server/system 1202.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “algorithm”, “process”, “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow..

What is claimed is:

1. A method for generating a natural language processing model for a particular industry without utilizing a predefined or historical dataset for that particular industry, the method comprising the actions of:
gathering data from one or more sources, wherein each of the one or more sources include data that is relevant to the particular industry;
aggregating the gathered data;
creating a language model from the aggregated data;
generating a training dataset;
launching the natural language processing model with the training dataset such that the natural language processing model is functional to the relevant industry upon launching.

2. The method of claim 1, wherein the action of gathering data from one or more sources further comprises the actions of:
obtaining a first set of intents from one or more experts in the particular industry; and
searching social media data forums related to the particular industry to obtain a second set of intents.

3. The method of claim 2, wherein the action of gathering data from one or more sources further comprises the actions of:
obtaining a third set of intents from historical data related to the particular industry; and
obtaining a fourth intents from industry specific data sources that include one or more processes that resemble a process in the particular industry.

4. The method of claim 3, wherein the action of gathering data from one or more sources further comprises the actions of:
obtaining a set of questions related to the particular industry;
run the questions through a search engine; and
convert the results of the search engine into a fifth set of intents.

5. The method of claim 4, further comprising the action of converting the first, second, third, fourth and fifth sets of intents into respective corpora.

6. The method of claim 1, wherein the action of aggregating the gathered data comprises aggregating the first, second, third, fourth and fifth sets of intents into respective corpora into a single corpus.

7. A system for generating a natural language processing model for a particular industry without utilizing a predefined or historical dataset for that particular industry, the system comprising:
a data collector configured to gather data from one or more sources, wherein each of the one or more sources includes data that is relevant to the particular industry;
an aggregator configured to aggregate the gathered data;
a language model generator configured to create a language model from the aggregated data;
a dataset generator configured to generate a training dataset; and
a processor configured to execute a natural language processing model with the training dataset such that the natural language processing model is functional to the relevant industry upon launching.

8. The system of claim 7, wherein the data collector is configured to:
obtain a first set of intents from one or more experts in the particular industry; and
search social media data forums related to the particular industry to obtain a second set of intents.

9. The system of claim 8, wherein the data collector is further configured to:
obtain a third set of intents from historical data related to the particular industry; and
obtain a fourth set intents from industry specific data sources that include one or more processes that resemble a process in the particular industry.

10. The system of claim 9, wherein the data collector is further configured to:
obtain a set of questions related to the particular industry;
run the questions through a search engine; and
convert the results of the search engine into a fifth set of intents.

11. The system of claim 10, further comprising an intent convertor configured to convert the first, second, third, fourth and fifth sets of intents into respective corpora.

12. The system of claim 7, wherein aggregator is further configured to aggregate the first, second, third, fourth and fifth sets of intents into respective corpora into a single corpus.
